(19) United States
(12) Patent Application Publication
(10) Pub. No.: US 2024/0076239 A1
(43) Pub. Date: Mar. 7, 2024

(54) LIGHT-WEIGHT FAST-DRY SELF-LEVELING CEMENTITIOUS GYPSUM UNDERLAYMENT WITH PARTICLE FILLERS

(71) Applicant: United States Gypsum Company, Chicago, IL (US)

(72) Inventors: Sriram K. Valluri, Grayslake, IL (US); David D. Pelot, Chicago, IL (US); Naveen Punati, Kildeer, IL (US); Derik Harlow, Lake Zurich, IL (US); Scott Cimaglio, Grayslake, IL (US); Karl G. Niessner, Mundelein, IL (US)

(21) Appl. No.: 18/116,484

(22) Filed: Mar. 2, 2023

Related U.S. Application Data
(60) Provisional application No. 63/400,934, filed on Aug. 25, 2022.

(51) Int. Cl. C04B 28/14; C04B 7/02; C04B 7/32; C04B 14/06; C04B 14/18; C04B 20/10; C04B 28/04; C04B 28/06

(52) U.S. Cl. CPC C04B 28/145; C04B 7/02; C04B 7/323; C04B 14/06; C04B 14/185; C04B 20/1037; C04B 28/04; C04B 28/065; C04B 2111/62

(57) ABSTRACT

Stucco-cement compositions with a shortened drying time, lighter weight, high strength and reduced expansion, the compositions comprising expanded perlite and preferably also calcium aluminate cement and/or calcium sulfoaluminate cement, and methods for making and using these compositions, including pourable and/or pumpable floor underlayment slurries and methods for forming high strength underlayment on different substrates.

### CROSS-REFERENCE TO RELATED APPLICATIONS

This application claims the benefit of priority from U.S. provisional patent application 63/400,934 filed Aug. 25, 2022, the entire disclosure of which is herein incorporated by reference in its entirety.

### TECHNICAL FIELD

This disclosure relates to compositions for cementitious gypsum underlayment with a shortened drying time, and methods.

### BACKGROUND

Cementitious gypsum formulations are commonly used in construction, including for making pourable/pumpable floor underlayment. After a floor underlayment is poured, it may take several days to dry. Various weather factors, including relative humidity and temperature, are known to influence the underlayment drying time.

It is recommended that floor underlayments are installed between 50° F. (10° C.) and 95° F. (35° C.) at the time of application and for 72 hours after installation of the floor underlayment. If poor drying conditions (high humidity, cold temperatures and/or overly hot temperatures) are encountered, then a drying process may take longer. Commercially available self-leveling floor underlayments may have a normal drying time of 5-7 days for ¾ inch to 1 inch thickness, with proper ventilation/good air flow (70° F. (21° C.), 50% relative humidity), but some additional drying time may be needed should weather conditions change, resulting in delaying a completion of construction project.

Thus, there remains the need in the field for underlayment compositions with a shortened drying time, wherein the compositions produce a floor underlayment drying sooner than in 5 days and yet having the dry strength within the acceptable range of about 2500 psi or higher.

At least some of these problems are addressed with compositions and methods provided in this disclosure.

### SUMMARY

In one aspect, this disclosure provides a composition for cementitious gypsum underlayment, wherein the composition is a dry mixture and comprises:
a) stucco;
b) expanded perlite with an average particle size ranging from about 30 μm to about 40 μm in an amount ranging from about 0.5 wt % to about 15 wt %;
c) optionally, hydraulic cement comprising one or more of the following cements: Portland cement, calcium aluminate cement, calcium sulfoaluminate cement or any combination therefore, wherein the hydraulic cement is in an amount from about 0.5 wt % to about 20 wt %;
d) a plasticizer;
e) a stabilizer comprising one or more polysaccharide gums; and
f) a defoamer.

Preferably, the expanded perlite is coated with a silicone, silane or siloxane coating and more preferably, the expanded perlite is coated with a silicone, silane or siloxane coating and has a relative density in the range from about 0.112 g/cm³ to about 0.350 g/cm³, particle sizes ranging from about 1 μm to about 150 μm, and an average particle size less than 45 μm. In some preferred embodiments, the expanded perlite may be coated with an organometallic silane monomer coating or an organometallic silicone polymer coating.

In some embodiments, the composition may comprise Portland cement in an amount from about 0.5 wt % to about 20 wt % or calcium aluminate cement in amount from about 0.5 wt % to about 20 wt %.

In some preferred embodiments, the plasticizer may comprise a polycarboxylate ether (PCE) dispersant in an amount from about 0.1 wt % to about 1 wt % and/or sodium lignosulfonate in an amount from about 0.05 wt % to about 0.5 wt %.

In some preferred embodiments, the stabilizer may comprise diutan gum.

In some preferred embodiments, the composition may comprise one or more of the following: xanthan gum, welan gum and/or diutan gum.

In some preferred embodiments, the composition may further comprise at least one of the following: a set accelerator, a set retarding agent, or any combination thereof.

In some embodiments, the composition may further comprise sand with a sand-to-the-composition ratio by weight in the range from about 1:1 w/w to about 4:1 w/w.

The composition may further comprise one or more of the following aggregates: sand, lime, calcium carbonate, rock, gravel, silica fume, clay, pumice, vermiculite, fly ash, slag, silica fume, or any combination thereof.

A particularly preferred embodiment of the composition may comprise, consist essentially of, or consist of:
82-90 wt % stucco;
1-15 wt % expanded perlite having an average particle size ranging from about 30 to about 37 μm and having a relative density ranging from about 0.244 g/cm³ to a 0.350 g/cm³;
2-10 wt % Portland cement;
1-10 wt % calcium aluminate cement and/or calcium sulfoaluminate cement;
0.1-1 wt % Polycarboxylate ether (PCE) based dispersant;
0.05-0.5 wt % lignosulfonate;
0.01-0.1 wt % polysaccharide gum; and
0.1-0.5 wt % defoamer.

In some embodiments, the composition may further comprise hollow glass, glass and/or borosilicate microspheres in addition to or instead of expanded perlite. In another aspect, this disclosure relates to a gypsum cement slurry comprising:
a) any of the compositions according to this disclosure;
b) sand; and
c) water in an amount ranging from about 100 cc to about 400 cc of water per 1,000 grams of the composition and sand;
   wherein a ratio of sand to the composition is in the range from 0.8:1 to 2.3:1 cubic feet of sand per an 80 lb of the composition.

In yet another aspect, this disclosure relates to a method for making a gypsum cement slurry, the method comprising: mixing one or more compositions according to this disclosure with water.

In yet further aspect, this disclosure relates to a method for producing floor or floor underlayment, the method comprising:
i. mixing a gypsum cement slurry comprising the composition of claim 1, water and sand in a mixing vessel, wherein water is used in an amount from about 150 cubic centimeters (cc) to about 300 cubic centimeters (cc) per 1,000 grams of the composition and sand; and wherein the weight by weight (w/w) ratio of the sand to the composition is in the range from 1:1 to 4:1; and
ii. applying the gypsum cement slurry to a substrate.

In some embodiments of the method, the gypsum cement slurry may be applied by pumping the gypsum cement slurry through a hose or dumping out of a reservoir. In some preferred embodiments of the method, the mixing step may further comprise adding one or more set retarders and/or set accelerators to the gypsum cement slurry. In some embodiments of the method, the slurry may be applied to the substrate at the ¾% inch to 4 inch thickness. Preferably, the underlayment has a compressive strength of at least 1,800 psi and more preferably, at least 2,000 psi.

### BRIEF DESCRIPTION OF THE DRAWINGS

FIG. 1 is a graph reporting that a slurry prepared with the stucco-cement composition according to this disclosure (referred as “Trial 1”) dries faster in comparison to a control composition which does not comprise expanded perlite or calcium sulfoaluminate cement. In the shown graph, 220 on Protimeter (Y-Axis) is considered as dry.

FIG. 2A is a graph reporting drying times for three compositions according to this disclosure in comparison to a control composition at 75° F. and 50% relative humidity at a 170 cc water demand.

FIG. 2B is a graph reporting drying times for three compositions according to this disclosure in comparison to a control composition at 73° F. and 20% relative humidity at a 170 cc water demand.

FIG. 2C is a graph reporting drying times for three additional compositions according to this disclosure and having different amounts of CAC in comparison to a control composition at 75° F. and 50% relative humidity at a 170 cc water demand.

FIG. 2D is a graph reporting drying times for three additional compositions according to this disclosure and having different amounts of perlite in comparison to a control composition at 75° F. and 50% relative humidity at a 170 cc water demand.

FIG. 3A is a graph reporting expansion (%) for a composition according to this disclosure and comprising CAC and perlite in comparison to a control composition.

FIG. 3B is a graph reporting expansion (%) for a composition according to this disclosure and comprising perlite (no CAC) in comparison to a control composition.

FIG. 3C is a graph reporting expansion (%) for a composition according to this disclosure and comprising Portland cement and perlite in comparison to a control composition.

### DETAILED DESCRIPTION

In one aspect, this disclosure relates to stucco-cement compositions comprising one or more particle fillers, preferably perlite, the compositions being particularly useful as a floor underlayment. When mixed with water, the compositions have an advantageously shortened drying time as compared to a control composition which does not comprise the particle filler. Additional technical advantages over conventional compositions include, but are not limited to, the compositions are light-weight and have reduced expansion when drying, while still maintaining the required compressive strength of at least 2500 psi or more.

Preferably, the stucco-cement compositions are dry mixtures which can be mixed with at least water and further preferably with one or more aggregates, more preferably including sand, and optionally other additives into a slurry.

In this disclosure, the term “calcined gypsum” may be used interchangeably with calcium sulfate hemihydrate, stucco, calcium sulfate semi-hydrate, calcium sulfate half-hydrate or plaster of Paris.

In this disclosure, the term “gypsum” may refer to any of the following: naturally mined gypsum (ore), landplaster and/or synthetic gypsum. The term “gypsum” may be used interchangeably with the term “calcium sulfate dihydrate.” The “synthetic gypsum” can be also referred to as “chemical gypsum.”

In this disclosure, the term “formulation” may be used interchangeably with the term “composition” and/or “mixture.” In this disclosure, some compositions (formulations or mixtures) may be referred to as “dry” composition or mixture if no water was added to the composition. In this disclosure, “dry” means that no water or other liquid was added to the composition or mixture. Nevertheless, a dry composition or dry mixture may have some moisture content. For example, a dry mixture may have a moisture content of about 1 wt % or less, about 0.05 wt % or less, or about 0 wt %. It should be noted that water molecules bound with stucco are not being considered as “free-water.”

In this disclosure, the term “about” means a range of plus/minus 5% of the stated value. For example, “about 100” means 100±5 and “about 200” means 200±10.

In this disclosure, the term “wt %” means percentage by weight.

When stucco (CaSO₄·½H₂O) is mixed with water into a slurry, stucco hydrates and sets into a gypsum matrix. This setting reaction can be described by the following equation:

CaSO₄·½H₂O+ 3/2H₂O→CaSO₄·2H₂O

In this disclosure, “the working time” refers to a time period, e.g., 10 minutes, 30 minutes or 2 hours, by the end of which a slurry sufficiently hardens into a gypsum matrix and is no longer considered workable.

In this disclosure, “calcination” means a process by which gypsum (CaSO₄·2H₂O) is dehydrated into calcined gypsum (CaSO₄·½H₂O). The process includes heating gypsum to evaporate crystalline water. Calcined gypsum can be produced in different crystalline forms such as alpha calcium sulfate hemihydrate and beta calcium sulfate hemihydrate. All crystalline forms and any mixtures thereof are suitable for compositions according to this disclosure.

In this disclosure, various tests are described. If no temperature, atmospheric pressure and/or humidity is disclosed in connection with a particular test, it means that the test was conducted at room temperature defined as 68 to 77° F. (20 to 25° C.), normal atmospheric pressure of about 101 kPa and a humidity in the range from about 68 to about 75 percent.

In this disclosure, ASTM tests refer to tests published by ASTM International, formally known as American Society for Testing and Materials. Detailed test protocols for ASTM tests are available from the ASTM International website.

The dry stucco-cement composition according to this disclosure may comprise at least the following components: 1) stucco; 2) one or more particle fillers; 3) hydraulic cement which is preferably a combination of Portland cement with calcium aluminum cement (CAC) and/or calcium sulfoaluminate cement; 4) one or more plasticizers, preferably a combination of at least one PCE plasticizer and at least one lignosulfonate; 5) one or more defoamers; 6) one or more sand stabilizers; and 7) optionally, other additives including those which control the setting reaction.

### Stucco

A first necessary component in the stucco-cement compositions of this disclosure is stucco (calcined gypsum, calcium sulfate hemihydrate, calcium sulfate semi-hydrate, calcium sulfate half-hydrate or plaster of Paris). Gypsum can be sourced from mines in the dihydrate form (CaSO₄·2H₂O), or in form of synthetic gypsum from flue gas desulfurization (FGD). Gypsum is then calcined in order to drive off some water, which produces calcium sulfate hemihydrate. Depending on various factors, including the source of gypsum and also a method by which gypsum is calcined, stucco can be produced in alpha-crystal form or beta-crystal form. Alpha crystals are less acicular than beta crystals. As described in U.S. Pat. No. 7,504,165, the entire disclosure of which is incorporated by reference, alpha-calcined gypsum differs in its water demand from beta-calcined gypsum, with alpha-calcined gypsum requiring less water for forming a flowable slurry.

In some embodiments, the stucco-cement composition according to this disclosure may comprise stucco in an amount ranging from about 70 wt % to about 99%, preferably from about 80 wt % to about 98 wt %, and most preferably from about 82 wt % to about 92 wt %. Suitable stucco may contain alpha calcium sulfate hemi-hydrate, beta calcium sulfate hemi-hydrate, calcined synthetic gypsum, or any mixtures thereof.

### Particle Filler

A second necessary component in the stucco-cement compositions of this disclosure is a particle filler. Preferred particle fillers include expanded perlite of a particular relative density and having particular particle sizes as described in more detail below and/or certain glass microspheres. The stucco-cement compositions may comprise from about 0.5 wt % to about 15 wt %, preferably from about 1.5 wt % to about 7 wt % and most preferably from about 2 wt % to about 6 wt % of the particle filler.

Perlite is a naturally occurring inorganic mineral known to be a hydrated natural glass composed of silicon, aluminum, and oxygen and containing occluded water. Methods for preparing expanded perlite are known, for example from U.S. Pat. No. 6,712,898, incorporated herein by reference. Conventional processing of perlite may include crushing and grinding perlite ore, screening through one or more sieves (for example, passing through U.S. 30 mesh), thermally expanding, milling, and separating according to a predetermined size. A process of thermal expansion can be performed in a furnace in which perlite is exposed to a heated air at a temperature in the range of 860-1100° C. Simultaneous softening of glass and evaporation of water produces expanded perlite with a significantly increased bulk volume in comparison to non-expanded perlite.

As described in U.S. Pat. Nos. 3,379,609, 8,347,575 and/or 8,038,790, the entire disclosures of which are herein incorporated by reference, expanded perlite can be used in building panels in order to decrease their weight, but it was generally known in the field that formulating a floor underlayment with expanded perlite may weaken the compressive strength of the underlayment, leading to a conclusion that perlite should not be used in floor underlayments where compressive strength is very important. In contrast to the general belief and unexpectedly, these inventors found that using expanded perlite of higher density and with smaller particles than what is typically used in panels decreases advantageously a drying time of the floor underlayment.

Preferred expanded perlites for the stucco-cement compositions according to this disclosure include expanded perlites with an average particle size less than 45 micrometers (μm), and more preferably with an average particle size less than 40 micrometers (μm). In particular, preferred expanded perlites may include those with an average particle size ranging from about 30 μm to about 40 μm, and most preferably an average particle size ranging from about 30 μm to about 37 μm. It is also important that preferred expanded perlites according to this disclosure do not contain, or contain only trace amounts, e.g., less than 1 wt %, of particles which are larger than 150 μm. Preferred size ranges for expanded perlite particles according to this disclosure may be in the range from about 1 μm to about 150 μm, and more preferably in the range from about 1 μm to about 110 μm.

In order to determine an average particle size and particle size ranges, a person of skill may conduct a particle-size analysis by sedimentation and/or with sieves. In addition to or instead of sedimentation and/or sieve analysis, a particle size distribution may be determined by measuring scattered light from a laser beam projected through a stream of perlite particles.

The sieve test may be conducted in accordance with ASTM D6913/D6913M-17 “Standard Test Methods for Particle-Size Distribution (Gradation) of Soils Using Sieve Analysis.” In this method, the percentage (by weight) of particles passing each sieve size is recorded to the nearest 1%. Thus, particle size distributions may be determined, based on a percentage of particles by weight retained on a sieve with openings of a predetermined size. Some of the U.S. sieve numbers and their corresponding opening sizes are listed in Table 1.

TABLE 1
U.S. Sieve Numbers

| U.S. Sieve Designation Number | Size of Opening (μm) |
|---|---|
| 50 | 300 |
| 70 | 210 |
| 100 | 150 |
| 200 | 75 |
| 325 | 45 |
| 450 | 32 |
| 635 | 20 |

The sedimentation analysis described in ASTM D7928-21e1 “Standard Test Method for Particle-Size Distribution (Gradation) of Fine-Grained Soils Using Sedimentation (Hydrometer) Analysis” may be then used for a material that is finer than the No. 200 (75 μm) sieve. This sedimentation analysis may be performed with a hydrometer following a procedure described in ASTM D7928-21e1.

A scattered light method for measuring a size distribution in a perlite sample is known for example from U.S. Pat. No. 6,712,898, the entire disclosure of which is herein incorporated by reference. The amount and direction of light scattered by the perlite particles is measured by an optical detector array and then analyzed with a computer which calculates the size distribution of the perlite particles in the sample stream. A suitable instrument for performing this method includes, but is not limited to, a Leeds and Northrup Microtrac X100 laser particle size analyzer. Any other laser particle size analyzer may be also used.

The “dry bulk density” of expanded perlite is measured as the mass or weight of the expanded perlite that is required to fill a container of a specified unit volume. For example, dry bulk density no less than 0.200 g/cm³ means that no less than 0.200 grams of expanded perlite are required to fill a container with the volume of one cubic centimeter. A person of skill may measure the dry bulk density by following a protocol in accordance with ASTM C-29/C29M—17a “Standard Test Method for Bulk Density (”Unit Weight“) and Voids in Aggregate.”

Preferred expanded perlites according to this disclosure may have a dry bulk density higher than what is typically used in gypsum panels. Specifically, the preferred dry bulk density of the expanded perlite may be higher than about 0.112 g/cm³, and more preferably no less than about 0.150 g/cm³, and most preferably in the range from about 0.170 g/cm³ to about 0.250 g/cm³. Acceptable dry bulk density ranges may include from about 0.112 g/cm³ to about 0.350 g/cm².

Preferred expanded perlites according to this disclosure may have a relative density (specific gravity) higher than expanded perlites used in panels. The “relative density” of expanded perlite is the ratio of its mass to the mass of an equal volume of water. A person of skill may measure the relative density by following a protocol in accordance with ASTM C128-15 “Standard Test Method for Relative Density (Specific Gravity) and Absorption of Fine Aggregate.”

Preferred expanded perlites according to this disclosure may have a relative density (specific gravity) higher than what is typically used in gypsum panels. The preferred relative density of the expanded perlite may be higher than about 0.170 g/cm³, and more preferably no less than about 0.244 g/cm³. Acceptable relative density ranges may include from about 0.170 g/cm³ to about 0.350 g/cm³.

While some of the expanded perlite may be used uncoated, the most preferred expanded perlites in the compositions of this disclosure are coated. Preferred coatings include hydrophobic film forming coatings which reduce the surface viscosity of expanded perlite. Suitable coatings include, but are not limited to silicone, silane and siloxane coatings, and in particular organometallic silane monomer coatings and organometallic silicone polymer coatings.

Some particularly preferred particle fillers according to this disclosure include a coated expanded perlite having a relative density higher than 0.112 g/cm³, e.g., in the range from about 0.175 g/cm³ to about 0.350 g/cm³ and particle sizes ranging from about 1μm to about 150 μm, and more preferably from about 1 μm to about 110 μm.

The stucco-cement compositions may comprise from about 0.5 wt % to about 15 wt %, preferably from about 1.5 wt % to about 7 wt % and most preferably from about 2 wt % to about 6 wt % of one or more expanded perlites according to this disclosure.

In addition to the expanded perlite or instead of the expanded perlite, the stucco-cement compositions according to this disclosure may comprise hollow glass, glass and/or borosilicate microspheres as particle filler, preferably soda lime borosilicate hollow glass microspheres with an average particle size in the range from about 65 μm to about 20 μm and having a relative density in the range from about 0.125 g/cm³ to about 0.460 g/cm³.

It was previously commonly accepted in the field that adding a light-weight filler such as expanded perlite may reduce the strength of floor underlayment, which is highly undesirable. In view of this, it is unexpected that the present disclosure provides compositions with a light-weight filler, preferably the expanded perlite, and one or more cements and these compositions produce a floor underlayment with a compressive strength comparable to conventional compositions formulated without perlite.

### Hydraulic Cement

A third component in the stucco-cement compositions of this disclosure is cement. In some compositions according to this disclosure, cement may be omitted. However, in some preferred embodiments, compositions according to this disclosure may comprise on or more cements. Suitable cements include Portland cement and/or blended hydraulic cements such as Portland-limestone cement, Portland-slag cement, Portland-pozzolan cement, or any mixture thereof. Preferred cements include, but are not limited to, Portland cement Type I/II, Type III or Type V, as defined in ASTM standard specification C150.

ASTM C150 specification defines Portland cement as a hydraulic cement produced by pulverizing clinker composed of hydraulic calcium silicates, and further containing one or more of calcium sulfate forms (anhydrate, dihydrate, and/or semi-hydrate) as a grinding aid. In order to manufacture Portland cement, a mixture of limestone and clay may be heated in a kiln, forming Portland cement clinker which is then co-ground with calcium sulfate as a grinding aid into Portland cement of desired fineness.

A particularly preferred cement is Cement Class C with high early strength, which meets ASTM standard specification C150 Type III. Portland Type III cement is similar to Portland Type I cement, but is ground finer to have a specific surface area of 50-60% higher than Portland Type I cement, which results in Type III cement having a better (higher) early age strength compared to Type I cement.

Some preferred compositions may include Type III or Type I Portland cement and more preferably, Type III Portland cement. Examples of other suitable cements which can be used to supplement or even replace Portland cement in some embodiments of the stucco-cement composition may include slag cement, blast-furnace slag cement, white cement and sulfoaluminate cement.

In some preferred embodiments of the stucco-cement composition, Portland cement or blended Portland cement, preferably Portland cement Type I or III, and more preferably Portland cement Type III, may be used in an amount ranging from about 0.5 wt % to about 20 wt %, preferably from about 1% to about 15% by weight, and most preferably from about 2 wt % to about 10 wt %.

It has been unexpectedly found that supplementing or replacing Portland cement with calcium aluminate cement (CAC) and/or calcium sulfoaluminate cement decreases significantly the drying time and increases compressive strength of a stucco-cement composition comprising the expanded perlite according to this disclosure as well as reduces the expansion of drying underlayment.

Calcium aluminate cements (CACs) are cements that have a high content of alumina, preferably at least 40 wt % or more, of which the main component may be mono calcium aluminate (CaAl₂O₄) among other calcium aluminates. In this disclosure, CAC cement may include Fondu cement also known under its French name as CIMENT FONDU. Preferably, CAC cements are free or substantially free of sulfates. Because of its high alumina content, CAC cement may have high refractory properties. A CAC cement may be also useful for increasing resistance to abrasion and a mechanical impact, especially during early stages of hardening. A CAC cement may be produced from a fused clinker with one method being disclosed and patented in 1908 to inventor J. Bied.

In some compositions according to this disclosure, CAC cement may be used in an amount from about 0.5 to about 20 wt %, and more preferably, from about 1 to about 10 wt %, and most preferably from about 1 to about 5 wt %. CAC cement may be used in combination with Portland cement in some embodiments. In other embodiments, CAC cement may be used instead of Portland cement.

In some embodiments, instead of CAC cement or in addition to CAC cement, at least some compositions according to this disclosure may comprise calcium sulfoaluminate cement. The main mineral components in calcium sulfoaluminate cement include anhydrous calcium sulfoaluminate, dicalcium silicate and gypsum. In some embodiments, calcium sulfoaluminate cement may be a blend of Portland cement with calcium sulfoaluminate mineral additives. In embodiments of the gypsum-cement compositions according to this disclosure, calcium sulfoaluminate cement may be used in an amount from about 0.5 to about 20 wt %, and more preferably from about 1 to about 4 wt %, and most preferably from about 1 to about 3 wt %.

Some preferred compositions according to this disclosure may comprise one or more of the following cements: Portland cement, preferably Portland cement Type I or III, calcium aluminate cement (CAC), calcium sulfoaluminate (CSA) cement, or any combination thereof. In some embodiments, the compositions according to this disclosure may comprise from about 0.5 to about 20 wt % of Portland cement Type I or III and from about 0.5 to about 10 wt %, preferably from about 1 to about 6 wt % and most preferably from about 1 to about 5 wt % calcium aluminate cement (CAC). In some embodiments, the compositions according to this disclosure may comprise from about 0.5 to about 20 wt % of Portland cement Type I or III and from about 0.5 to about 15 wt %, preferably from about 1 to about 4 wt % and most preferably from about 1 to about 4 wt % calcium sulfoaluminate (CAS) cement.

In some embodiments, the compositions according to this disclosure may comprise from about 0.5 to about 20 wt % of Portland cement Type I or III and from about 0.5 to about 15 wt %, preferably from about 1 to about 4 wt % and most preferably from about 1 to about 4 wt % a mixture of CAC and CAS cements mixed in a ratio in the range from 1:100 to 100:1 by weight.

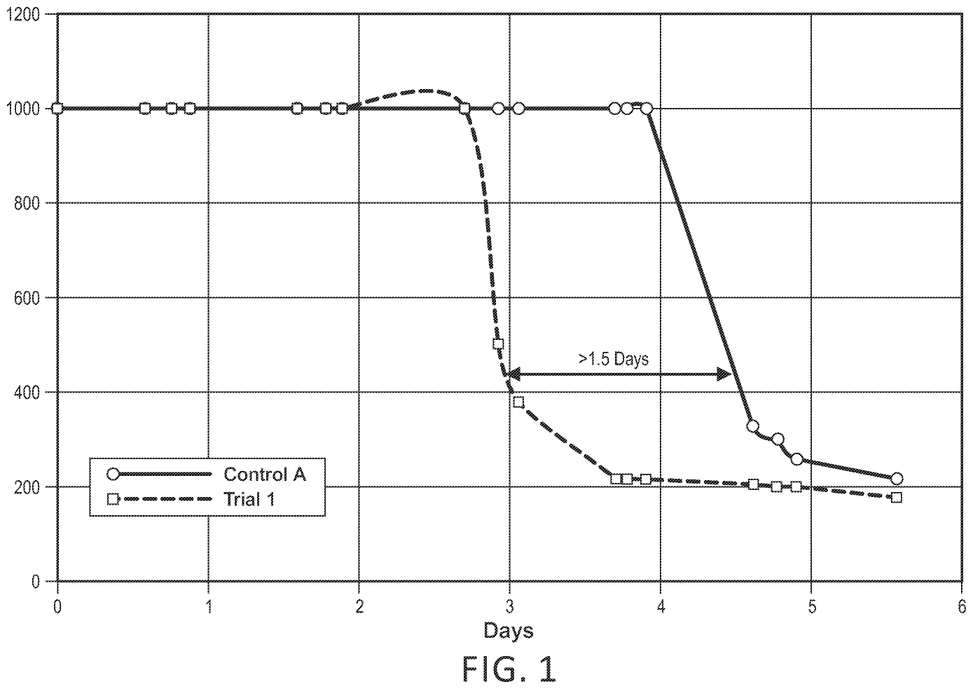

It has been unexpectedly found that adding at least one of CAC and/or CAS cements rather than using Portland cement alone improves significantly technical characteristics of the underlayment mixture according to this disclosure and comprising perlite. These technical advantages include, but are not limited to, the resulting mixtures have a faster drying time, lighter weight and a reduced expansion, as discussed in more detail below, including by a comparative analysis reported in FIGS. 1, 2A-2D and 3A-3C.

### Plasticizers

A fourth component in the stucco-cement compositions according to this disclosure may include one or more plasticizers which are used in order to reduce water amounts needed for producing a workable slurry. Suitable plasticizers include, but are not limited to, polycarboxylates, lignosulfonates, naphthalene sulfonates, melamine sulfonates, polyacrylates, or any combination thereof. In some preferred embodiments, the plasticizer may be used in concentrations from about 0.05 wt % to about 2 wt %, more preferably from about 0.1 wt % to about 1 wt %, and most preferably, from about 0.1 wt % to about 1 wt %.

Particularly preferred plasticizers may include, but are not limited to, polycarboxylate ether (PCE) based dispersants, naphthalene sulfonate formaldehyde polycondensates, sulfonated melamine polycondensates or acrylic-acid co-polymers as described in U.S. Pat. Nos. 6,777,517 and 7,504,165, and U.S. Pat. No. 8,088,218, incorporated herein by reference.

Some preferred plasticizers may include polycarboxylate ether (PCE) based dispersants having a comb-like structure containing polyethylene glycol side chains and carboxylic or phosphate groups as charge carrier or one or more lignosulfonates, preferably sodium lignosulfonate.

The plasticizers may be used separately or in combination. In some embodiments, at least one polycarboxylate plasticizer, preferably polycarboxylate ether (PCE) dispersant, is used in combination with at least one lignosulfonate, preferably sodium lignosulfonate. Most preferably the PCE dispersant is used in an amount from about 0.05 wt % to about 1 wt % and the at least one lignosulfonate, preferably sodium lignosulfonate is used in an amount from about 0.05 wt % to about 1 wt %.

### Stabilizers

A fifth component in the stucco-cement composition of this disclosure may include a compound preventing sedimentation of sand and other aggregates in a water-based slurry made with the stucco-cement composition. Preferably, the stabilizer may contain one or more polysaccharide gums which help in reducing sedimentation of sand from a slurry. Suitable polysaccharide gums may contain two or more kinds of monosaccharides forming a repeating unit which is then polymerized into a polysaccharide gum. Exemplary monosaccharides include, but are not limited to, galactose, arabinose, xylose, glucose, rhamnose, and/or glucuronic acid, among others. Suitable polysaccharide gums can be produced by fermentation, for example, as disclosed in U.S. Pat. Nos. 5,175,278 and 6,110,271, the disclosure of which is herein incorporated by reference. Preferred polysaccharide gums may include xanthan gum, diutan gum and/or welan gum. In some embodiments, diutan gum is particularly preferred.

Particularly preferred polysaccharide gums include diutan gum which a high-molecular weight gum that can be produced by controlled aerobic fermentation.

If present in the stucco-cement composition, one or more poly polysaccharide gums may be used in any amount, and preferably in the range from about 0.001 wt % to 1 wt %, and more preferably in the range from about 0.01 wt % to about 0.5 wt %, and most preferably from about 0.01 wt % to about 0.1 wt %.

### Defoamers

The stucco-cement compositions according to this disclosure may comprise one or more defoamers which may help in reducing surface defects cause by air bubbles while a floor underlayment is drying. Suitable defoamers include those based on fatty alcohol-alkoxylates and polysiloxane on an inorganic carrier material, commercially available from various sources.

Some preferred embodiments of the stucco-cement composition according to this disclosure may contain at least one defoamer in an amount from about 0.05 wt % to about 1 wt %, more preferably from about 0.1 wt % to about 0.8% by weight, and most preferably, from about 0.1 wt % to about 0.5 wt %.

Some preferred embodiments include the stucco-cement composition as described in table 2.

TABLE 2
Stucco-Cement Composition

| | | Preferred | Most Preferred |
|---|---|---|---|
| | Concentration | Concentration | Concentration |
| Component | Range (wt %) | Range (wt %) | Range (wt %) |
| Stucco | 70-99 | 80-98 | 82-90 |
| Particle Filler (e.g., | 0.5-15 | 1.5-7 | 2-6 |
| expanded perlite with | | | |
| average particle size | | | |
| ranging from about | | | |
| 30 μm to about 40 | | | |
| μm and having a | | | |
| relevant density in | | | |
| the range from about | | | |
| 0.112 g/cm³ to about | | | |
| 0.350 g/cm³) | | | |
| Hydraulic cement | 0.5-15 | 1-6 | 2-5 |
| comprising Portland | | | |
| Cement or Blended | | | |
| Portland Cement | | | |
| Calcium Aluminate | 0.5-15 | 1-4 | 1-3 |
| Cement (CAC) | | | |
| and/or Calcium | | | |
| Sulfoaluminate | | | |
| (CAS) Cement | | | |
| 1^{st} Plasticizer | 0.05-2 | 0.1-1 | 0.1-1 |
| (e.g., PCE) | | | |
| 2^{nd} Plasticizer | 0.05-2 | 0.1-1 | 0.1-1 |
| (lignosulfonate) | | | |
| Stabilizer (e.g., | 0.001-1 | 0.01-0.5 | 0.01-0.1 |
| diutan gum) | | | |
| Defoamer | 0.05-1 | 0.1-0.8 | 0.1-0.5 |

### Other Additives

The stucco-cement compositions according to this disclosure may further comprise various additives which may be added to the stucco-cement composition prior to its packaging and/or at the construction site when the stucco-cement composition is mixed with water. Preferred additives include, but are not limited to, at least one compound used for controlling the setting reaction of calcined gypsum. Such additives may include set accelerators and/or set retarding agents.

Some preferred set accelerators may include, but are not limited to, calcium sulfate (anhydrous), calcium sulfate dihydrate, potassium sulfate, aluminum sulfate, sodium sulfate, sodium disulfate, or any combination thereof.

Preferably, the set accelerator may include calcium sulfate dihydrate that has been finely ground. In some embodiments, calcium sulfate dihydrate may be formulated as the climate stabilized accelerator which may contain about 95 wt % of calcium sulfate dihydrate co-ground with 5 wt % sugar and then heat processed, as was originally described in U.S. Pat. No. 3,573,947, herein incorporated by reference. In some embodiments, calcium sulfate dihydrate may be formulated as a heat resistance accelerator (“HRA”) which comprises calcium sulfate dihydrate freshly co-ground with sugar, e.g., sucrose or dextrose, at a ratio of about 5 to about 25 pounds of sugar per 100 pounds of calcium sulfate dihydrate, as was originally described in U.S. Pat. No. 2,078,199, herein incorporated by reference.

Any of these set accelerators, and preferably the climate stabilized accelerator, may be added in a small amount, e.g., less than 2 wt % and preferably from about 0.001 to about 2 wt %, based on the dry weight of to the stucco-cement composition either prior to the stucco-cement composition being packaged and shipped, or at the construction sited directly prior to its use and mixing of the stucco-cement composition with water.

Set retarding agents can be used in order to increase the working time (workability) of the stucco-cement slurry. Any set retarding agents suitable for slowing a hydration reaction of calcium sulfate hemihydrate can be used, including, but not limited to, proteinaceous retarder (SUMA™), diethylenetriamine pentaacetic acid (DTPA), tartaric acid, citric acid, maleic acid and/or their corresponding salts, including in particular, potassium sodium tartrate, sodium citrate, and/or cream of tartar (potassium bitartrate). A set retarding agent can be optionally added to the stucco-cement composition in small amounts, e.g., between 0.0125 wt % and 1.5 wt %, preferably between 0.05 wt % and 1.0 wt %, and most preferably between 0.05 wt % and 0.5 wt %.

The stucco-cement compositions according to this disclosure may further optionally comprise other additives including, but not limited to, at least one biocide, at least one pH adjuster, a coloring agent (pigment, stain, or dye, e.g., titanium dioxide), or any combination thereof. Any of these additives may be added in a small amount.

Biocides are commonly used for preventing growth of mildew and mold. One example of a suitable biocide is boric acid. A biocide can be optionally added to the stucco-cement composition in small amounts, e.g., from 0.0125% and 1.5% by weight, preferably, between 0.05% and 1% by weight and most preferably, between 0.05% and 0.5% by weight.

### Aggregates

The stucco-cement compositions according to this disclosure can be mixed with sand and optionally with some other aggregates. Preferred sands include, but are not limited to, fine sands, however, coarser sands can be also used. Suitable sands include, but are not limited to, river sand, Mohawk medium sand, Rich Mix fine sand, Atlanta sand, Dothan Sand, and Florida sand. Fine sands can be used in combination with coarser sands.

An amount of sand depends on application. In some embodiments, from about 100 parts by weight to up to 300 parts by weight of sand per 100 parts by weight of the stucco-cement composition, which can be abbreviated as the sand-to-the-stucco-cement composition ratio from about 1:1 w/w to about 3:1 w/w.

In some embodiments according to this disclosure, the stucco-cement compositions and/or gypsum cement slurries made with the composition may comprise other aggregates in addition to or even instead of sand. Such suitable aggregates that can be used in gypsum cement mixtures according to this disclosure may include, but are not limited to, lime, calcium carbonate, rock, gravel, silica fume, clay, pumice, vermiculite, fly ash, slag, silica fume, or any combination thereof. An amount of each aggregate depends on a particular application and the aggregate type.

In yet another aspect, this disclosure provides gypsum cement slurries suitable in various construction applications, including as a pourable/pumpable self-leveling floor underlayment. These gypsum cement slurries can be prepared by mixing the stucco-cement composition of this disclosure and at least water and optionally further at least one aggregate, preferably sand. These water-based slurries are typically prepared at a construction site and used promptly after water has been added. As discussed above, some additives, e.g., a set retarding agent and/or a set accelerator, a defoamer and/or a biocide and/or one or more aggregates may be added while preparing a slurry.

An amount of water to be used in the slurry depends on application. One of the technical advantages of the stucco-cement compositions according to this disclosure is that they can be used in low-water gypsum cement slurries which are particularly useful for pouring a floor underlayment with acceptable strength and rapid set.

In some preferred embodiments, suitable gypsum cement slurries according to this disclosure may be prepared with water in an amount from about 100 cubic centimeters (which can be abbreviated in this disclosure as cc) to about 400 cubic centimeters of water per 1,000 grams of dry components in the gypsum cement slurry or gypsum cement and aggregate slurry.

In this disclosure, low-water gypsum cement slurries include any gypsum cement slurries which are formulated with about 100 cc to about 300 cc, preferably about 100 cc to about 200 cc, and most preferably about 150 cc to about 200 cc of water per 1,000 grams of dry components in the gypsum cement slurry or gypsum cement and aggregate slurry.

Thus, one of the technical advantages is that gypsum cement slurries can be prepared with low amounts of water. Surprisingly, these low-water gypsum cement slurries are pourable and self-leveling.

The slurries may be prepared with higher amounts of sand because it has been found that a stable sand suspension may be achieved at a ratio of sand to the stucco-cement composition in the range from 0.8:1 to 2.3:1, for example, 1:1, or 1.4:1 or 1.9:1, as expressed in units of cubic feet of sand per 80 lb of the stucco-cement composition.

Some preferred embodiments include those in which from about 1.4 to about 1.9 cubic feet of sand is mixed per each 80 pounds of the stucco-cement composition of this disclosure. In some preferred embodiments, sand and water are mixed with the stucco-cement composition just prior to application. However, in some embodiments, at least a portion of sand can be premixed with the stucco-cement composition during manufacturing and/or prior to shipment to a construction site.

The stucco-cement compositions according to this disclosure which comprise calcium aluminate cement (CAC), calcium sulfoaluminate cement and/or the expanded perlite with the average particle sizes and relative densities as described above provide several technical advantages over a control composition which does not comprise CAC cement, calcium sulfoaluminate cement or the expanded perlite, but otherwise comprises the same components. Specifically, it has been determined that the stucco-cement compositions according to this disclosure when mixed with water have a shorter drying time in comparison to control compositions mixed with the same amount of water. The stucco-cement compositions may dry faster than the control by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39% or at least 40%.

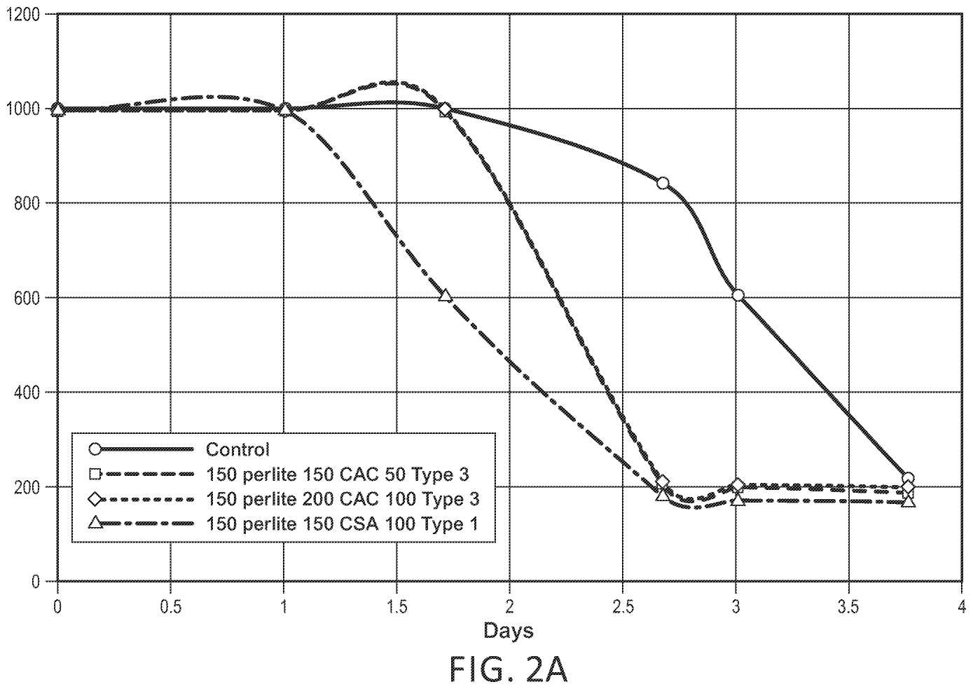

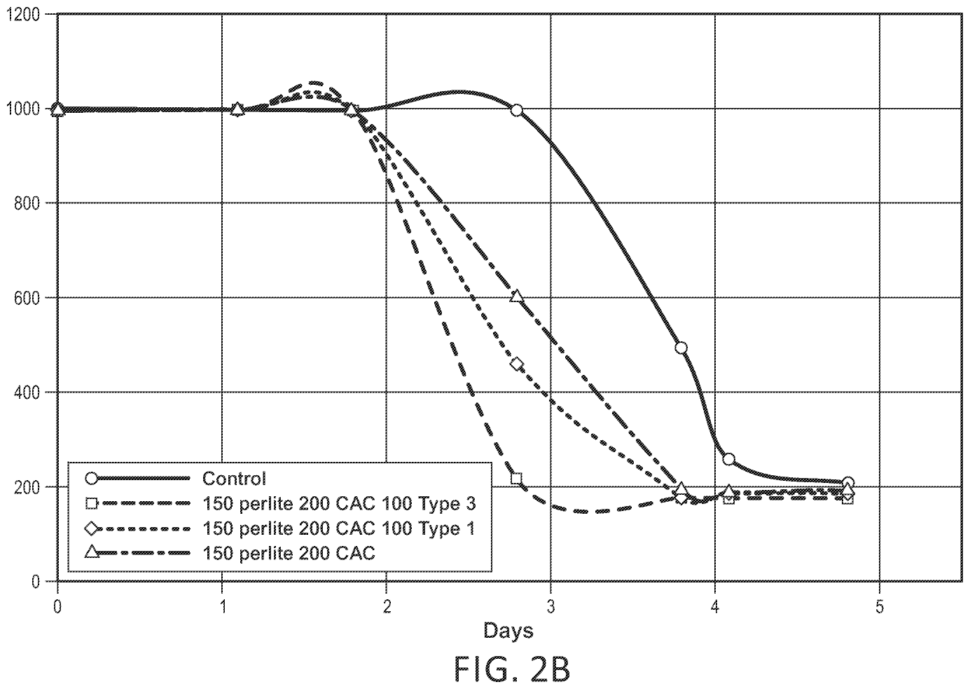

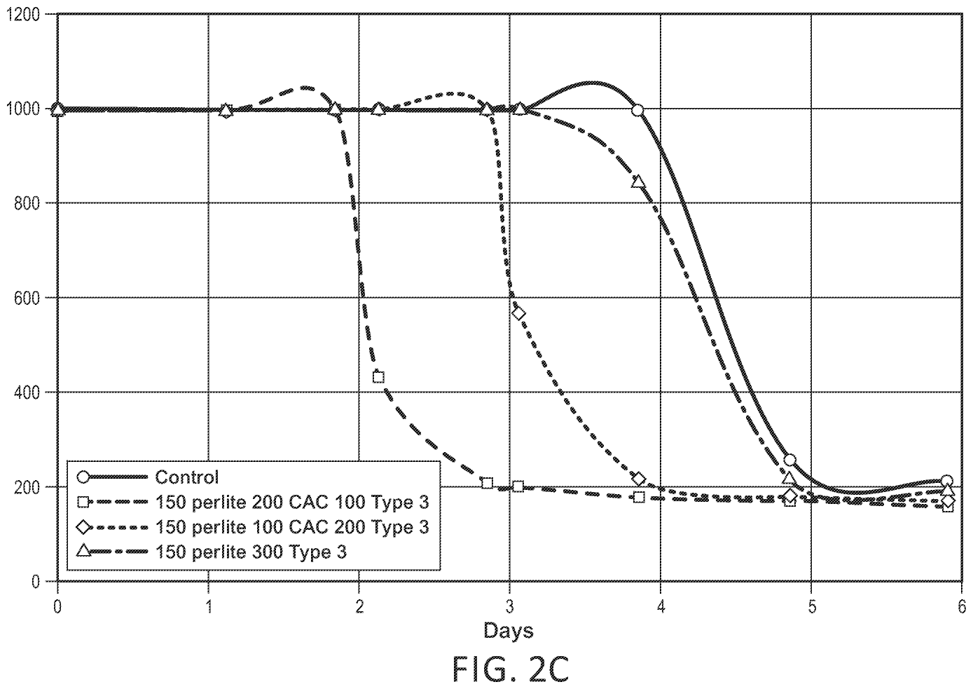

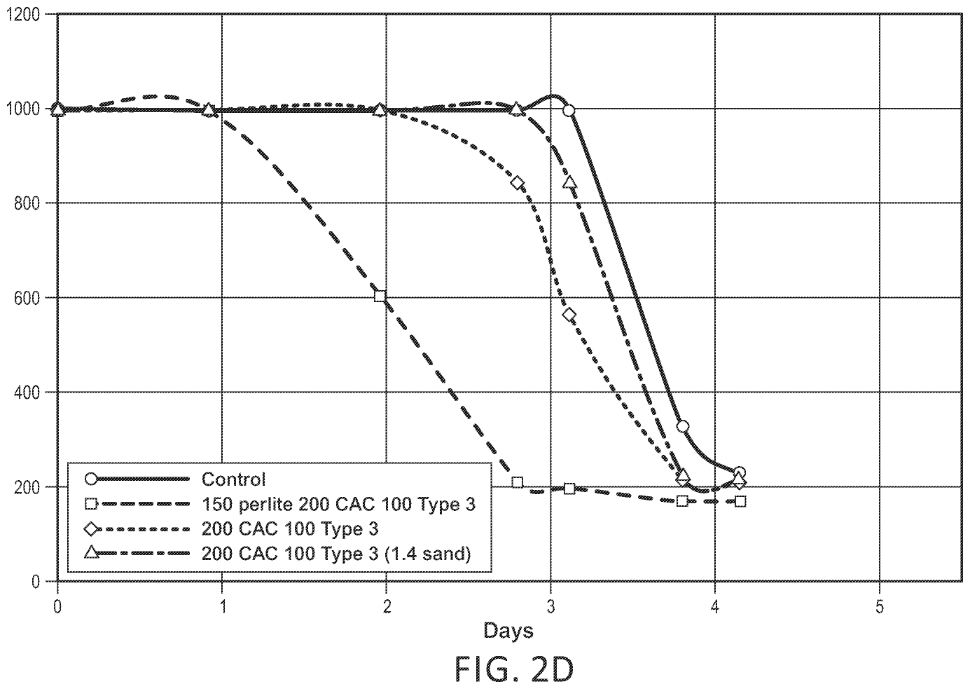

In order to monitor a drying process, a person of skill may use a Protimeter moisture meter (protimer.com) as described for example in connection with data reported in FIGS. 1 and 2A-2D. Two different models are acceptable for this purpose: the Surveymaster® and the Aquant®. The entire floor should be surveyed to identify those spots which are taking longer to dry.

Typically, a reading of 200 or less on the Protimeter moisture meter indicates less than 1% moisture content. This underlayment is sufficiently dried to be worked on.

Referring to FIG. 1, a control composition (did not comprise the expanded perlite or CAC/CSA cement) or the stucco-cement composition (the same components as the control composition, plus the expanded perlite according to this disclosure and CSA cement according to this disclosure) was mixed with water and sand, and then poured into a ½-inch to 3/2-inch-thick samples. Using a Protimeter, measurements were taken three times per day at regular intervals and plotted. A sample is considered to be dry when the Protimeter reads 220 or lower. As reported in FIG. 1, a sample prepared with the stucco-cement composition according to this disclosure dried about 1.5 days sooner than the control sample, providing a significant technical advantage in being less dependent on weather conditions and allowing a construction crew to install underlayment at least 30% faster than with the control sample.

Referring to FIG. 2A-2D, a control composition (did not comprise the expanded perlite or CAC/CSA cement) or various stucco-cement compositions (the same components as the control composition, plus the expanded perlite according to this disclosure and CAC cement according to this disclosure) was mixed with water and sand, and then poured into a ½-inch to 3/2-inch-thick samples. Using a Protimeter, measurements were taken three times per day at regular intervals and plotted. A sample is considered to be dry when the Protimeter reads 200 or lower. As reported in FIG. 2A-2D, a sample prepared with the stucco-cement composition according to this disclosure dried about 2 days sooner than the control sample, providing a significant technical advantage in being less dependent on weather conditions and allowing a construction crew to install underlayment at least 30% and more preferably, at least 40% faster than with the control sample.

Another technical advantage of the stucco-cement compositions according to this disclosure is that while the compositions have a shorter drying time, the compositions still retain a compressive strength comparable to that of the control composition. The stucco-cement compositions according to this disclosure may have a compressive strength of at least 1,800 and more preferably at least 2,000 psi or higher, even in low-thickness applications wherein the underlayment is poured at the ¾ inch thickness and sand is used in an amount of 1.9 cubic feet of sand per 80 lb of the stucco-cement composition. Thus, the stucco-cement compositions according to this disclosure are suitable for low-thickness applications in single-family homes, multi-family buildings and other dwellings.

In order to measure the compressive strength, a person of skill may use the following protocol. Aggregated two-inch cubes are used to test the density and compressive strength. Cube molds are prepared by sealing the bottom of the mold with petroleum jelly to prevent leaking and lubricating the molds with an approved release agent, such as WD-40. A sample material is then poured into the corner of the cubes until they were approximately ¾ full, stirring to keep the sand suspended if needed. Using a small spatula, the sample material is vigorously agitated from corner to corner for 3-5 seconds, eliminating all bubbles in the cube. The cubes are then filled to slightly overfull, and the remaining sample material is poured into the set cup for additional testing. The excess sample is screeded from the cube molds ten minutes after Vicat set and the cubes are carefully removed from the molds approximately 50 minutes later. About 24 hours after the cubes are made, they are placed in a 110° F. (43° C.) forced air oven for eight days until constant weight is achieved.

The density of the samples is determined by weighing a number of dried cubes and applying the following formula:

Density (lb/ft³)=(Weight of cubes*0.47598)÷number of cubes

The cubes are used to test for compressive strength using a compressive strength testing machine (SATEC UTC 120 HVL) programmed to meet the rate of loading specified by procedure ASTM C 109. The maximum load required to crush the cube is then measured. A cube is placed between two plates of the machine. A force is applied to the cube as the plates are pushed together. The machine records pounds of force that were required to crush the cube. The total force in pounds is then converted to pounds per square inch (psi) by dividing by the surface area of the sample, in this case 4 in² (25 cm²).

Yet another technical advantage of the stucco-cement compositions according to this disclosure is that the compositions are self-leveling as was measured in the slump test in which the stucco-cement composition or control composition was dry blended with sand first and then mixed with water until fully mixed. The initial slump sample was poured into a dry 2″×4″ (5 cm×10 cm) cylinder placed on a plastic sheet, slightly overfilling the cylinder. Excess material was screeded from the top, then the cylinder was lifted up smoothly, allowing the slurry to flow out the bottom, making the patty. The patty was measured (± 1/16″) in two directions 90° apart, and the average reported as the patty diameter.

Preferable formulations according to this disclosure include those which produce a patty having a diameter of about 9 inches. It was determined that even as the compositions according to this disclosure dry faster than the control compositions, the compositions according to this disclosure still have the initial self-leveling property similar to that of the control composition.

Yet another technical advantage of the compositions according to this disclosure is a lighter weight than control compositions. The stucco-cement compositions produce the same volume of underlayment but from a lighter weight mixture, resulting in savings during transportation and storage. This also provides a technical advantage for constructing an underlayment that weighs less but has the same acceptable compressive strength as the control composition.

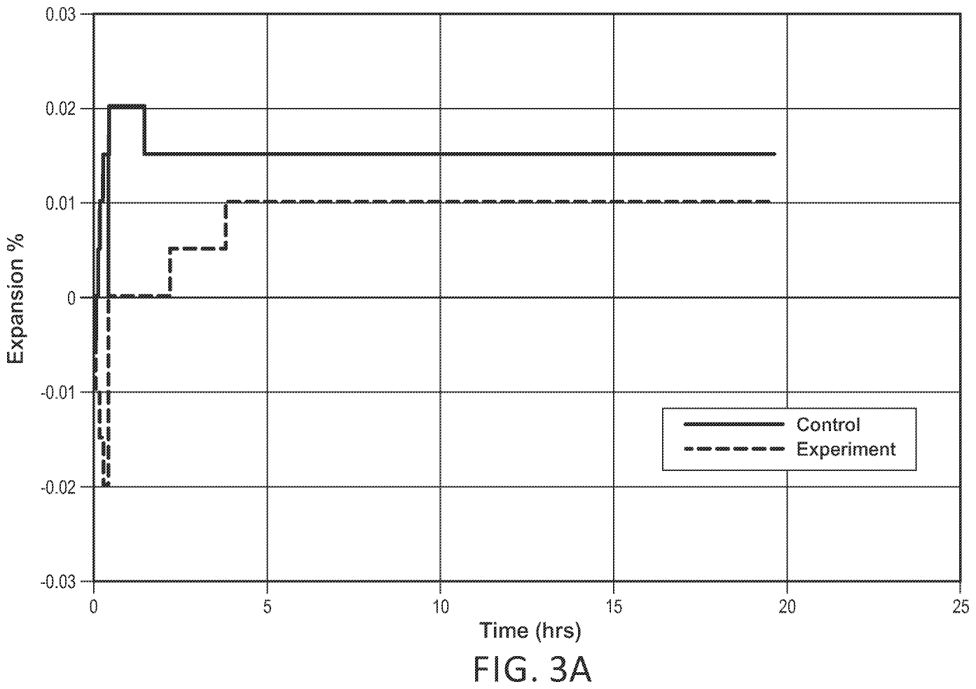

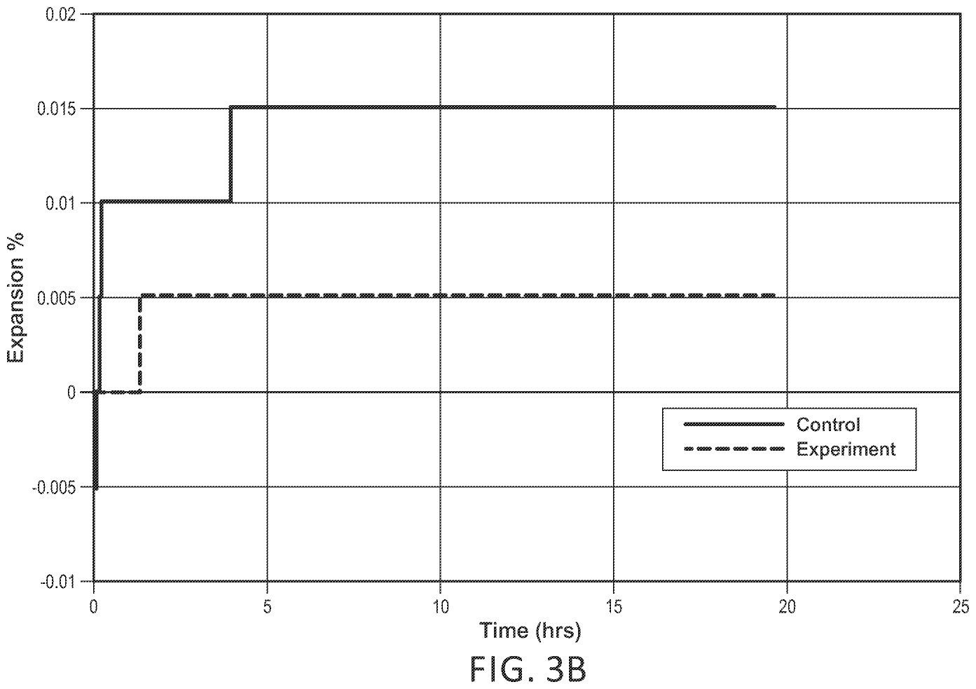

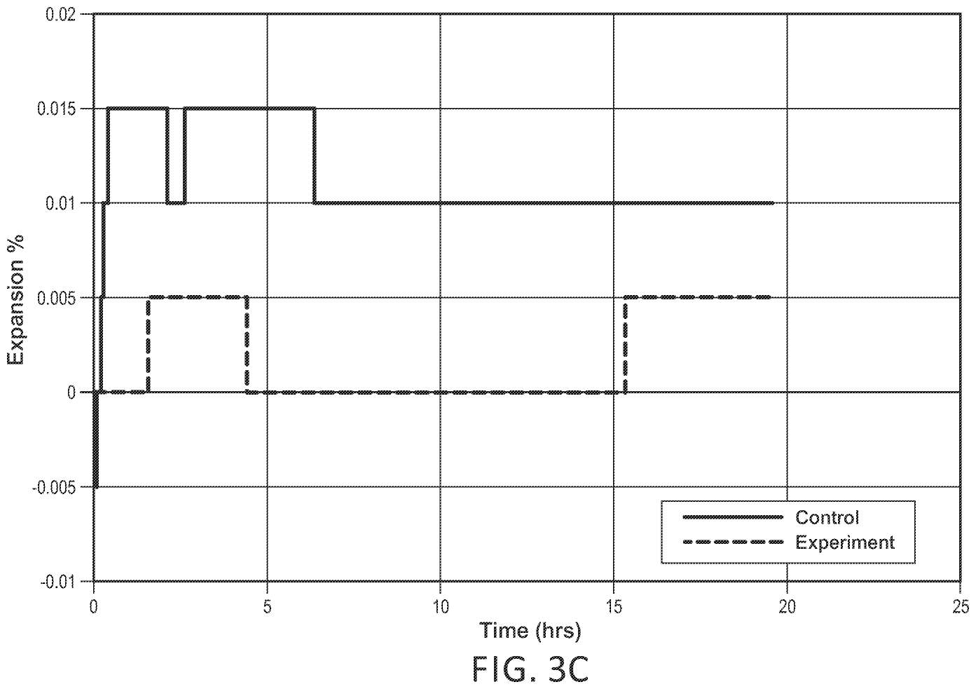

Yet another technical advantage of the compositions according to this disclosure is that the compositions have a reduced expansion as shown in FIGS. 3A-3C.

Some applications for the gypsum concrete slurries according to this disclosure include, but are not limited to, floor underlayment, including, a self-leveling underlayment, anhydrite/gypsum floor screeds, panel technologies, including structural panels and access panels, and gypsum cement products that comprise glass beads and/or perlite. Suitable applications for gypsum cement slurries according to this disclosure may include as a building material in wood-frame and/or concrete construction for floor leveling and/or fire ratings. In addition, the gypsum cement slurries according to this disclosure can be also used as joint grouts or as a repair patch for cracks and other panel defects.

The gypsum-cement slurries according to this disclosure can be applied to a great variety of different substrates, including, but not limited to, wood, steel, concrete, tiles, and/or gypsum wallboard.

In yet another aspect, this disclosure provides a method for producing floor or floor underlayment. These methods may include preparing a gypsum cement slurry at a jobsite where floor or underlayment is to be laid by mixing in a mixing vessel the stucco-cement composition of this disclosure, one or more aggregates, preferably containing sand, with a measured amount of water. The gypsum cement slurry is then applied, pumped, dumped or poured onto a substrate and allowed to set, forming floor or floor underlayment. Suitable substrates may include wood or concrete. In some applications, floor or underlayment surface may be optionally finished by any technique known in the field, including, but not limited to, floating, pinrolling or screeding.

One preferred embodiment includes methods in which a gypsum cement slurry may be pumped through a hose in order to produce a self-leveling underlayment or floor. In these applications, the gypsum cement slurry is formulated to be free flowing, by using an appropriate amount of water. Another preferred embodiment includes methods in which a gypsum cement slurry may be dumped dumping out of a reservoir, where the reservoir can be a holding tank or mixer. Any holding tanks of mixers typically used for pouring a floor underlayment may be used, with one example being a portable mixer MEGA-HIPPO™ available from Portamix Ltd.

Unexpectedly, it was discovered that the gypsum cement slurries of this disclosure may be prepared as highly fluid and yet, advantageously, these slurries still dry sufficiently in a time period shorter, e.g., by at least 10 hours, at least one day or at least 2 days, than an underlayment made with a control composition that does not comprise the expanded perlite or at least one from calcium aluminate cement and CSA cement. The amount of water to be used in these applications can be also within the ranges considered to be low-water ranges, e.g., from about 100 to about 350 cc, and more preferably from about 100 to about 350 cc of water per 1,000 gm of dry powder.

After the underlayment dries, it may be used as a floor itself or as an underlayment for installing any covering over it, including, but not limited to, laminate, carpet, hardwood, ceramic tiles, porcelain tiles, vinyl sheets and vinyl tiles.

A further description will now be provided by the way of the following non-limiting examples.

### EXAMPLE 1

The following two dry mixtures (Control Composition A or Stucco-Cement Composition B) were prepared by blending together components listed in Table 3.

TABLE 3

| | Control | Stucco-Cement |
|---|---|---|
| | Composition A | Composition B |
| Category/Material | % dry basis | % dry basis |
| Stucco | 96.14% | 85.43% |
| Perlite | 0.00% | 4.44% |
| Portland Cement | 2.50% | 8.88% |
| PCE Plasticizer | 0.55% | 0.74% |
| Lignosulfonate Plasticizer | 0.10% | 0.09% |
| Defoamer | 0.12% | 0.11% |
| Diutan Gum Stabilizer | 0.05% | 0.04% |

### EXAMPLE 2

Stucco cement compositions were prepared by using components listed in table 3 with modifications as to the perlite and its amount as listed in table 4 below. The compositions were weighed and then mixed with water and sand at a ratio of 1.9 into slurries which were analyzed in the slump test and poured into samples which were analyzed for compressive strength and drying time.

TABLE 4

| | | | | Water | | | % faster | Final |
|---|---|---|---|---|---|---|---|---|
| | | | CSA | (cc/ | | Compressive | drying | bag |
| | Perlite | Cement | cement | 1,000 | Slump | Strength at | than | weight |
| Filler | wt % | wt % | wt % | gm) | (in) | 7 days (psi) | Control* | (lbs.) |
| Control | 0% | 2.5% | 0% | 160 | $9 \frac{12}{16}$ | 2531 | n/a | 80 |
| Control | 0% | 2.5% | 0% | 140 | $8 \frac{7}{8}$ | 3240 | n/a | 80 |
| Control | 0% | 3% | 1.5% | 140 | $9 \frac{3}{16}$ | 4034 | n/a | 81 |
| 50/23 Perlite* | 3.45% | 2.5% | 1.5% | 160 | $9 \frac{4}{16}$ | 1885 | 20% | 64.8 |
| 50/23 Perlite* | 2.51% | 3% | 1.5% | 160 | $9 \frac{3}{16}$ | 2256 | 15% | 68.40 |
| 50/23 Perlite* | 2.1% | 3% | 1.5% | 160 | $8 \frac{7}{8}$ | 2825 | 5% | 72.08 |
| 50/34 Perlite** | 1.92% | 3% | 1.5% | 160 | $9 \frac{3}{16}$ | 2701 | 20% | 69.44 |
| 43/23 Perlite*** | 1.32% | 3% | 1.5% | 160 | $9 \frac{3}{16}$ | 2965 | 10% | 69.2 |
| 43/34 Perlite**** | 1.32% | 3% | 1.5% | 160 | $8 \frac{7}{8}$ | 2434 | 10% | 69.34 |
| 35/34 | 1.14% | 3% | 1.5% | 160 | 9 | 2343 | 5% | 67.5 |
| Perlite***** | | | | | | | | |

*50/23 Perlite has a relative density in the range from 0.310 to 0.345 g/cm³, an average particle size of 32 μm and is coated with a silane monomer coating.
**50/34 Perlite has a relative density in the range from 0.310 to 0.345 g/cm³, an average particle size of 32 μm and is coated with a silicone polymer coating.
***43/23 Perlite has a relative density in the range from 0.244 to 0.277 g/cm³, an average particle size of 37 μm and is coated with a silane monomer coating.
****43/34 Perlite has a relative density in the range from 0.244 to 0.277 g/cm³, an average particle size of 37 μm and is coated with a silicone polymer coating.
*****35/34 Perlite has a relative density in the range from 0.228 to 0.250 g/cm³, an average particle size of 40 μm and is coated with a silicone polymer coating.

### EXAMPLE 3

Stucco-cement compositions were prepared by using components listed in table 3 with modifications as to the perlite and its amount as listed in table 5 below. The compositions were weighed, mixed with water into slurries (neat samples) or the compositions were mixed with water and sand (sanded samples) and then were poured into samples which were analyzed as listed in table 5 below. In neat samples, 360 cc of water was used for 1000 gm of the composition. In sanded samples, 165 cc of water was used for 1000 gm of the composition and sand design was 1.9.

TABLE 5

| | | | | Dry powder | | | | | |
|---|---|---|---|---|---|---|---|---|---|
| | | | | bulk density | Neat | Sanded | | 7-day | Bag |
| | Perlite | Cement | CSA | (compacted), | density, | density, | Sanded | Strength, | weight |
| | wt % | wt % | wt % | pcf | pcf | pcf | slump | psi | (lb.) |
| Control | 0% | 2.5% | 0% | 74.91 | 100.3 | 121.8 | 9 3/16 | 3641 | 80 |
| Perlite | 4.1% | 2.5% | 0% | 64.93 | 86.9 | 118.9 | 9 4/16 | 2555 | 69 |
| 50/23 | | | | | | | | | |
| Perlite | 4.1% | 5.2% | 2% | 67.42 | 88.9 | 119.4 | 9 2/16 | 3874 | 72 |
| 50/23 | | | | | | | | | |

### EXAMPLE 4

Stucco-cement compositions were prepared by using components listed in table 3 with modifications as to the perlite as listed in table 6 below. The compositions were weighed, mixed with water and sand, and then were poured into samples which were analyzed as listed in table 6 below. These compositions were also used in the dryness analysis, results of which are shown in FIG. 1.

TABLE 6

| | | | | | | | | | % | |
|---|---|---|---|---|---|---|---|---|---|---|
| | | | | | | | | Dry | faster | |
| | | | | | | | | time at | drying | Bag |
| | Perlite | Cement | Water | Sand | Slump | Set | Strength | 1 inch | than | weight |
| Name | wt % | wt % | (cc) | design | (inch) | (min) | (psi) | (Days) | control | (lbs) |
| Control A | 0% | 2.5% | 165 | 1.9 | 9 | 300 | 2460 | 5.10 | — | 80 |
| Trial 1 | 4.44% | 8.88% | 165 | 1.9 | 9 | 140 | 2330 | 3.60 | 30% | 67 |

### EXAMPLE 5

Stucco cement compositions were prepared by using components listed in table 3 with modifications as listed in table 7 below.

TABLE 7

| | Portland | Portland | | | | | | | |
|---|---|---|---|---|---|---|---|---|---|
| Total | Cement | Cement | CSA | FONDU | Perlite | Water | | 7-Day | |
| Stucco | type 1 | type 3 | cement | cement | 50/23 | (cc) per | | Dry | Drying |
| lbs. | lbs. | lbs. | lbs. | lbs. | lbs. | 1000 g | Sand | Strength | (% |
| (% wt.) | (% wt.) | (% wt.) | (% wt.) | (% wt.) | (% wt.) | mix | Design | (psi) | faster) |
| 2883 | 300 | — | — | — | 150 | 165 | 1.9 | 2551 | 16% |
| (86.3%) | (9%) | (0%) | (0%) | (0%) | (4.5%) | | | | |
| 2883 | 300 | — | — | — | 150 | 175 | 1.9 | 2115 | 30% |
| (86.3%) | (9%) | (0%) | (0%) | (0%) | (4.5%) | | | | |
| 2883 | — | 400 | — | — | 150 | 165 | 1.9 | 2300 | 20% |
| (84.2%) | (0%) | (11.3%) | (0%) | (0%) | (4.3%) | | | | |
| 2883 | 300 | — | 100 | — | 150 | 175 | 1.9 | 2028 | 38% |
| (83.8%) | (8.71%) | (0%) | (2.9%) | (0%) | (4.4%) | | | | |
| 2883 | 600 | — | — | — | 150 | 165 | 1.9 | 2528 | 5% |
| (79.7%) | (16%) | (0%) | (0%) | (0%) | (4%) | | | | |
| 3080 | 300 | — | — | 100 | 130 | 170 | 1.9 | 2362 | 24% |
| (85.1%) | (8.28%) | (0%) | (0%) | (2.76%) | (3.59%) | | | | |
| 3080 | 400 | — | — | — | 100 | 175 | 1.9 | 2615 | 15% |
| (85.8%) | (11.15%) | (0%) | (0%) | (0%) | (2.79%) | | | | |
| 3403 | — | 50 | — | 100 | 130 | 165 | 1.9 | 2639 | 39% |
| (92%) | (0%) | (1.38%) | (0%) | (2.76%) | (3.59%) | | | | |
| 3403 | — | 100 | — | 150 | 130 | 165 | 1.9 | 3054 | 40% |
| (89.8%) | (0%) | (2.61%) | (0%) | (3.92%) | (3.4%) | | | | |
| 3403 | — | 50 | — | 150 | 130 | 165 | 1.9 | 2635 | 37% |
| (90.7%) | (0%) | (1.36%) | (0%) | (4.08%) | (3.54%) | | | | |
| 3403 | — | 50 | — | 150 | 150 | 170 | 1.9 | 2081 | 32% |
| (90.4%) | (0%) | (1.33%) | (0%) | (3.98%) | (3.98%) | | | | |
| 3403 | — | 100 | — | 200 | 150 | 170 | 1.9 | 2906 | 32% |
| (88%) | (0%) | (2.6%) | (0%) | (5.2%) | (3.9%) | | | | |
| 3403 | 100 | — | 150 | — | 150 | 170 | 1.9 | 2302 | 34% |
| (89.3%) | (2.62%) | (0%) | (3.93%) | (0%) | (3.93%) | | | | |
| 3810 | 186 | — | — | — | — | 170 | 1.9 | 3205 | 0% |
| (95.1%) | (4.65%) | (0%) | (0%) | (0%) | (0%) | | | | |
| 3680 | — | 100 | — | 200 | — | 170 | 1.9 | 4476 | 15% |
| (92.2%) | (0%) | (2.51%) | 0% | (5%) | (0%) | | | | |
| 3680 | — | 100 | — | 200 | — | 170 | 1.4 | 6582 | 5% |
| (92.2%) | (0%) | (2.51%) | 0% | (5%) | (0%) | | | | |

Drying results for compositions in Table 7 are reported in FIGS. 2A-2D. The drying studies were conducted in the 75F/50% RH environment. Protimeter Aquant® moisture meter was used to measure the relative dryness of the underlayment slab. Protimeter reads values from 999 to 0. A number below 200 on the protimeter indicates that the sample is dry. Pinless Protimeter uses radio frequency to detect moisture ¾″ (20 mm) below the surface.

In FIGS. 2A-2D, the 150 perlite 150 FONDU 50 Type 3 signifies 150 lbs. of perlite, 150 lbs. of CAC and 50 lbs. of Type 3 cement per batch. A control sample has no perlite and 186 lbs. of Type 1 cement.

Results of dryness experiments are reported in FIGS. 2A-2D. As can be seen in FIGS. 2A-2D, when CAC or CSA cement is combined with Portland cement, the mixture improves significantly the early age strength in underlayment embodiments according to this disclosure. Portland Type III mixed with CAC not only contributes to the strength, but also enhanced the stage one drying by consuming the excess water in the underlayment gypsum matrix, after it sets. Table 7 shows the strengths and drying performance of different cement combinations with stucco and perlite.

Expansion studies for some compositions in Table 7 are reported in FIGS. 3A-3C. Expansion studies were conducted as follows. As can be seen in FIGS. 3A-3C, the compositions according to this disclosure which comprise perlite, and preferably Portland cement and perlite and more preferably Portland cement in combination with CAC cement and perlite, expand less than a control composition which does not comprise perlite and/or a combination of Portland cement with CAC cement.

What is claimed is:

1. A composition for cementitious gypsum underlayment, wherein the composition is a dry mixture and comprises:
a) stucco;
b) expanded perlite in an amount ranging from about 0.5 wt % to about 15 wt %;
c) optionally, hydraulic cement comprising one or more of the following cements:
Portland cement, calcium aluminate cement, calcium sulfoaluminate cement or any combination therefore, wherein the hydraulic cement is in an amount from about 0.5 to about 20 wt %;
d) a plasticizer;
e) a stabilizer comprising one or more polysaccharide gums; and
f) a defoamer.

2. The composition of claim 1, wherein the expanded perlite is coated with a silicone, silane or siloxane coating.

3. The composition of claim 1, wherein the expanded perlite is coated with a silicone, silane or siloxane coating and has a relative density in the range from about 0.112 g/cm³ to about 0.350 g/cm³, particle sizes ranging from about 1 μm to about 150 μm, and an average particle size less than 45 μm.

4. The composition of claim 1, wherein the expanded perlite is coated with an organometallic silane monomer coating or an organometallic silicone polymer coating.

5. The composition of claim 1, wherein the composition comprises Portland cement in an amount from about 0.5 wt % to about 20 wt %, or calcium aluminate cement in an amount from about 0.5 wt % to about 20 wt %.

6. The composition of claim 1, wherein the plasticizer comprises a polycarboxylate ether (PCE) dispersant in an amount from about 0.1 wt % to about 1 wt % and/or sodium lignosulfonate in an amount from about 0.05 wt % to about 0.5 wt %.

7. The composition of claim 1, wherein the stabilizer comprises diutan gum.

8. The composition of claim 1, wherein the polysaccharide gum includes one or more of the following: xanthan gum, welan gum and/or diutan gum.

9. The composition of claim 1, wherein the composition consists essentially of:
82-90 wt % stucco;
1-15 wt % expanded perlite having an average particle size ranging from about 30 to about 37 μm and having a relative density ranging from about 0.244 g/cm³ to about 0.350 g/cm³;
2-10 wt % Portland cement;
1-10 wt % calcium aluminate cement and/or calcium sulfoaluminate cement;
0.1-1 wt % Polycarboxylate ether (PCE) based dispersant;
0.05-0.5 wt % lignosulfonate;
0.01-0.1 wt % polysaccharide gum; and
0.1-0.5 wt % defoamer.

10. The composition of claim 1, wherein the composition further comprises at least one of the following: a set accelerator, a set retarding agent, or any combination thereof.

11. The composition of claim 1, wherein the composition further comprises sand and wherein the sand-to-the-composition ratio by weight is in the range from about 1:1 w/w to about 4:1 w/w.

12. The composition of claim 1, wherein the composition further comprises one or more of the following aggregates: sand, lime, calcium carbonate, rock, gravel, silica fume, clay, pumice, vermiculite, fly ash, slag, silica fume, or any combination thereof.

13. The composition of claim 1, wherein the composition further comprises hollow glass, glass and/or borosilicate microspheres in addition to or instead of expanded perlite.

14. A gypsum cement slurry comprising:
a) the composition of claim 1;
b) sand; and
c) water in an amount ranging from about 100 cc to about 400 cc of water per 1,000 grams of the composition and sand;
wherein a ratio of sand to the composition is in the range from 0.8:1 to 2.3:1 cubic feet of sand per an 80 lb of the composition.

15. A method for making a gypsum cement slurry, the method comprising: mixing the composition of claim 1 with water.

16. A method for producing floor or floor underlayment, the method comprising:
i. mixing a gypsum cement slurry comprising the composition of claim 1, water and sand in a mixing vessel, wherein water is used in an amount from about 150 cubic centimeters (cc) to about 300 cubic centimeters (cc) per 1,000 grams of the composition and sand; and wherein the weight by weight (w/w) ratio of the sand to the composition is in the range from 1:1 to 4:1; and
ii. applying the gypsum cement slurry to a substrate.

17. The method of claim 16, wherein the gypsum cement slurry is applied by pumping the gypsum cement slurry through a hose or by dumping out of a reservoir.

18. The method of claim 16, wherein the mixing further comprises adding one or more set retarders and/or set accelerators to the gypsum cement slurry.

19. The method of claim 16, wherein the slurry is applied to the substrate at the ¾ inch to 4 inch thickness.

20. The method of claim 16, wherein the underlayment has a compressive strength of at least 1,800 psi.
